(19) United States
(12) Patent Application Publication
(10) Pub. No.: US 2021/0277928 A1
(43) Pub. Date: Sep. 9, 2021

(54) BOLT AND NUT ASSEMBLY WITH LOOSENING PREVENTION

(71) Applicant: Core Bolt Co., Ltd., Gwangju (KR)

(72) Inventor: Young Kwon KIM, Haenam-gun (KR)

(73) Assignee: Core Bolt Co., Ltd., Gwangju (KR)

(21) Appl. No.: 16/851,061

(22) Filed: Apr. 16, 2020

(30) Foreign Application Priority Data
Mar. 4, 2020 (KR) 10-2020-0027400

(51) Int. Cl. F16B 39/08

(52) U.S. Cl. CPC F16B 39/08

(57) ABSTRACT

A bolt and nut assembly with loosening prevention including: a bolt; a nut screw-coupled with a screw thread of the bolt; an anti-loosening cap for receiving the nut therein to prevent the nut from moving in a loosening direction that the nut is released from the bolt; and a nut locking member coupled with the screw thread of the bolt penetrating through the nut, and accommodated in the anti-loosening cap together with the nut. The anti-loosening cap includes: a nut receiving cap for receiving the nut therein; and a bolt receiving cap disposed at an upper portion of the nut receiving cap and having a bolt exposure hole for exposing an end portion of the bolt penetrating through the nut to the outside. The nut locking member includes a coil spring coupled with the screw thread of the bolt, which penetrates through the nut in a predetermined length.

### CROSS-REFERENCE TO PRIOR APPLICATIONS

The application claims priority of Korean Patent Application No. 10-2020-0027400, filed on Mar. 4, 2020, which is hereby incorporated by reference in its entirety.

### BACKGROUND OF THE INVENTION

### Field of the Invention

The present invention relates to an anti-loosening bolt and nut assembly (i.e., a bolt and nut assembly with loosening prevention), and more particularly, to an anti-loosening bolt and nut assembly, which can firmly maintain a coupled state of a bolt and a nut even though vibration is continuously applied so as to stably keep a combined state of a structure fastened by the bolt and the nut.

### Background Art

Bolts and nuts are commonly used in order to fasten two or more members with each other in various facilities or devices, such as mechanical machines, piers, steel towers, ships, vehicles, aircrafts, and so on.

Conventional bolts and nuts are coupled with each other in a male-and-female form to fasten two members with each other. However, when vibration or shock is continuously applied from the outside to the coupled part in the state where the bolt and the nut are screw-coupled with each other, the bolt and the nut gradually get loose in the opposite direction to the direction that the bolt and the nut are screw-coupled.

For instance, bolts and nuts used for rails disposed for running of railroad cars have a disadvantage in that the bolts and the nuts get loose due to vibration and shock generated when a railroad car runs.

Moreover, when the coupled state of the bolts and the nuts get loose, there occurs a gap between rails, and it may cause a big accident.

Such a loosening phenomenon between the bolts and the nuts may occur in various sites or devices besides the above case.

Especially, in industrial sites that strong shock or vibration is continuously applied to the coupled parts of the bolts and the nuts, it is keenly required to come up with measures to solve safety problems caused by loosening of the bolts.

### SUMMARY OF THE INVENTION

Accordingly, the present invention has been made to solve the above-mentioned problems occurring in the prior arts, and it is an object of the present invention to provide an anti-loosening bolt and nut assembly, which can firmly maintain a coupled state between a bolt and a nut even though vibration is continuously applied from the outside.

It is another object of the present invention to provide an anti-loosening bolt and nut assembly, which can limit movement of the nut in a direction that the nut gets loose from the bolt.

It is a further object of the present invention to provide an anti-loosening bolt and nut assembly, which can use the existing bolts and nuts as they are without changing the designs of the existing bolts and nuts.

To accomplish the above object, according to the present invention, there is provided an anti-loosening bolt and nut assembly including: a bolt inserted into an object to be fastened; a nut screw-coupled with a screw thread of the bolt; an anti-loosening cap for receiving the nut therein to prevent the nut from moving in a loosening direction that the nut is released from the bolt; and a nut locking member coupled with the screw thread of the bolt penetrating through the nut, and accommodated in the anti-loosening cap together with the nut in order to limit a rotational direction of the anti-loosening cap so that the nut is not rotated in the loosening direction, wherein the anti-loosening cap includes: a nut receiving cap for receiving the nut therein; and a bolt receiving cap disposed at an upper portion of the nut receiving cap and having a bolt exposure hole for exposing an end portion of the bolt penetrating through the nut to the outside, and the nut locking member includes a coil spring coupled with the screw thread of the bolt, which penetrates through the nut, in a predetermined length to limit the rotational direction of the anti-loosening cap.

The anti-loosening bolt and nut assembly according to the present invention can limit what the anti-loosening cap is rotated in the direction that the nut is released since the nut and the nut locking member accommodated in the anti-loosening cap apply tension in the direction that the nut is coupled to the bolt.

Moreover, the anti-loosening bolt and nut assembly according to the present invention can limit what the anti-loosening cap moves in the separation direction from the nut since the cap locking member coupled to the outer circumferential surface of the anti-loosening cap is inserted into the anti-loosening cap and gets in contact with the nut locking member.

Due to the action of the nut locking member and the cap locking member, the anti-loosening cap just rotates in the direction that the nut is coupled to the bolt and cannot rotate and move in other directions.

Therefore, the anti-loosening bolt and nut assembly according to the present invention can stably keep the coupled state of the bolt and nut and firmly maintain the combined state of the fastening members combined by the bolt and nut even though shock and vibration are applied in various directions.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1 and 2 is a perspective view showing a state where a bolt and nut assembly with loosening prevention according to the present invention is fastened;

FIG. 3 is an exploded perspective view showing a structure of the anti-loosening bolt and nut assembly according to the present invention;

FIGS. 4A and 4B show a structure of an anti-loosening cap of the anti-loosening bolt and nut assembly according to the present invention;

FIGS. 5A and 5B show a structure of a nut locking member of the anti-loosening bolt and nut assembly according to the present invention;

FIG. 6 is a view showing a structure of a cap locking member of the anti-loosening bolt and nut assembly according to the present invention;

FIG. 7 is a view showing an example of a process of fastening two members using the anti-loosening bolt and nut assembly according to the present invention;

FIG. 8 is a sectional view showing a cross section of the fastened state of the two members using the anti-loosening bolt and nut assembly according to the present invention; and

FIGS. 9A and 9B show a modification of an anti-loosening cap of the anti-loosening bolt and nut assembly according to the present invention.

### DETAILED DESCRIPTION OF THE PREFERRED EMBODIMENT

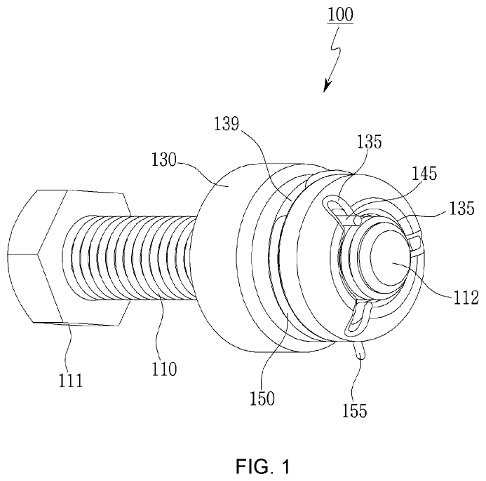

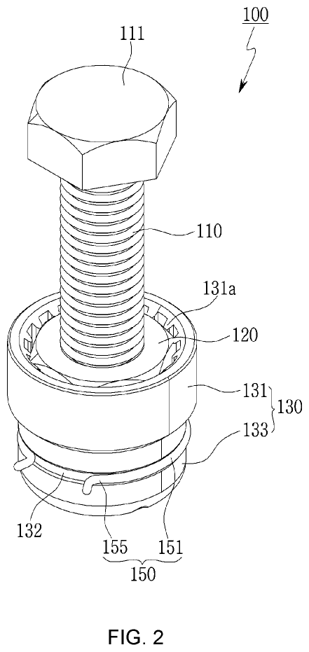

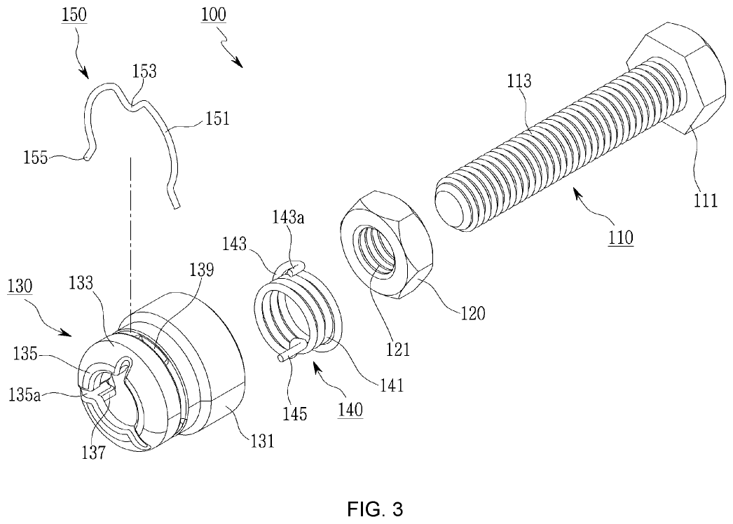

FIGS. 1 and 2 is a perspective view showing a state where an anti-loosening bolt and nut assembly according to the present invention is fastened, and FIG. 3 is an exploded perspective view showing a structure of the anti-loosening bolt and nut assembly according to the present invention.

The anti-loosening bolt and nut assembly 100 according to the present invention prevents that a nut 120 coupled to a bolt 110 is loosened from the bolt 110 to stably maintain the coupled state of the bolt 110 and the nut 120 for a long time when a user fastens two or more members using the bolt 110 and the nut 120.

The anti-loosening bolt and nut assembly 100 according to the present invention includes: a bolt 110 which penetrates through a plurality of members to be fastened; a nut 120 screw-coupled to the bolt 110; an anti-loosening cap 130 for accommodating the nut 120 therein to prevent the nut 120 from moving in a loosening direction; a nut locking member 140 accommodated in the anti-loosening cap 130 together with the nut 120 to limit a rotational direction of the anti-loosening cap 130 so that the nut 120 does not rotate in a loosening direction; and a cap locking member 150 for limiting what the anti-loosening cap 130 moves in a direction that the anti-loosening cap 130 is separated from the nut 120.

The anti-loosening bolt and nut assembly 100 according to the present invention limits what the nut 120 moves in the loosening direction since the anti-loosening cap 130 and the nut locking member 140 are fastened to the bolt 110 and the nut 120. Moreover, the cap locking member 150 also limits that the anti-loosening cap 130 moves in the direction that the anti-loosening cap 130 is separated from the nut 120. Therefore, the fastened state among the bolt 110, the nut 120 and the fastened members can be maintained stably.

The bolt 110 and the nut 120 may be one among known various forms. The bolt 110 has a spiral screw thread 113 formed on the outer circumferential surface and a bolt head 111 disposed at an upper portion thereof. The nut 120 is screw-coupled with the screw thread 113 of the bolt 110. The nut 120 has a bolt coupling hole 121 formed in the middle thereof to be coupled with the bolt 110, and a screw thread formed on the inner wall surface of the bolt coupling hole 121 to correspond to the screw thread 113.

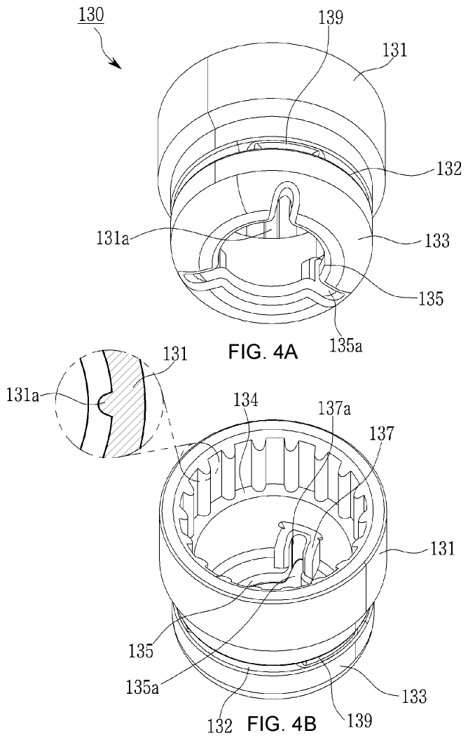

The anti-loosening cap 130 is covered on the nut 120 coupled to the bolt 110 in order to fix the position of the nut 120 so that the nut 120 is not moved in the loosening direction. FIGS. 4(a) and 4(b) are perspective views showing the structure of the anti-loosening cap 130 in different directions.

As shown in FIGS. 2 and 4, the anti-loosening cap 130 includes a nut receiving cap 131 for receiving the nut 120, and a bolt receiving cap 133 for receiving a rear end portion of the bolt 110 and the nut locking member 140, wherein the nut receiving cap 131 and the bolt receiving cap 133 are combined with each other integrally.

The nut receiving cap 131 receives the nut 120 therein. In order to receive the nut 120, the nut receiving cap 131 has an inner diameter corresponding to an outer diameter of the nut 120. As shown in FIG. 4B, a plurality of nut fixing protrusions 131a are formed on the inner wall surface of the nut receiving cap 131. The nut fixing protrusions 131a come into contact with the surface of the nut 120 of a hexagonal shape in order to fix the nut 120 not to be rotated.

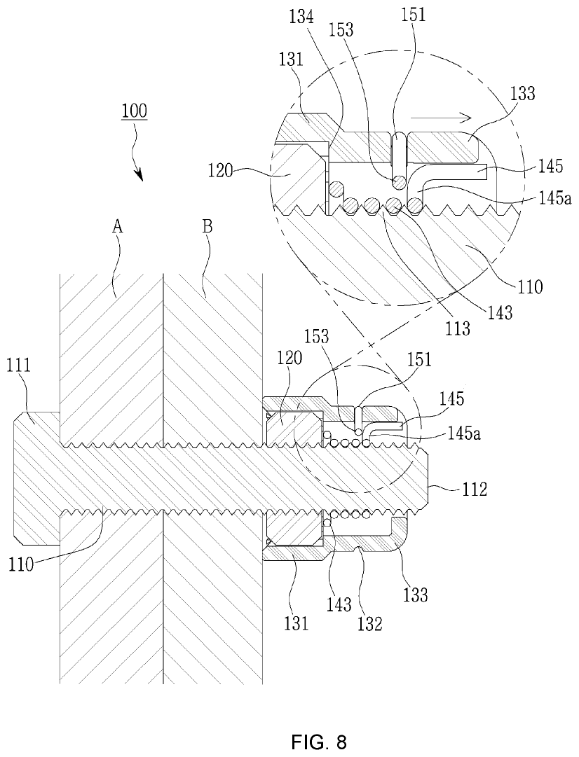

The bolt receiving cap 133 is formed on the upper surface of the nut receiving cap 131 to a predetermined length. The bolt receiving cap 133 penetrates through the nut 120 and receives the end portion of the bolt 110 outwardly exposed from the nut 120 and the nut locking member 140. The bolt receiving cap 133 has an inner diameter smaller than the nut receiving cap 131. That is, as shown in FIG. 8, the inner diameter of the bolt receiving cap 133 is smaller than the outer diameter of the nut 120.

Because the bolt receiving cap 133 has an inner diameter smaller than the nut receiving cap 131, a stepped wall 134 exists between the bolt receiving cap 133 and the nut receiving cap 131. Because the nut 120 is coupled with torque, when the end portion of the nut receiving cap 131 lowers down a contact section of the nut 120, the end portion of the nut receiving cap 131 may be damaged. Therefore, the stepped wall 134 is formed to fix the position of the nut receiving cap 131 and prevent the end portion of the nut receiving cap 131 from lowering down the contact section of the nut 120 anymore.

The bolt receiving cap 133 has a bolt exposure hole 135 formed at an upper end of the bolt receiving cap 133 to expose an end portion 112 of the bolt 110 to the outside. Moreover, as shown in FIG. 4B, a plurality of spindle insertion tubes 137 protrudingly formed on the inner wall surface of the bolt receiving cap 133 to be spaced apart from one another at a predetermined interval in a circumferential direction.

The spindle insertion tubes 137 are formed on the inner wall surface of the bolt receiving cap 133 to have a predetermined length in the axial direction. Each of the spindle insertion tubes 137 protrudes inwardly in a radial direction, and has a spindle insertion groove 137a recessed therein.

As shown in FIG. 3, after the nut 120 is coupled to the bolt 110, the nut locking member 140 is combined with the bolt 110. The anti-loosening cap 130 is covered on the nut 120 in the state where the nut locking member 140 is combined with the bolt 110. In this instance, a lower release spindle 143a protruding on the outer circumferential surface of the nut locking member 140 is accommodated in an empty space between the spindle insertion tube 137 and the inner wall surface of the bolt receiving cap 133, and a cap combining spindle 145 is combined with the spindle insertion tube 137.

In this instance, a plurality of spindle exposure holes 135a are formed in the outer circumference of the bolt exposure hole 135 to communicate with the spindle insertion tubes 137. The spindle exposure holes 135a are formed such that a user can visually check the positions of the cap combining spindle 145 of the nut locking member 140 and the spindle insertion tube 137 from the outside when the anti-loosening cap 130 is combined with the nut 120. Therefore, it is not required to expose the cap combining spindle 145 to the outside of the spindle exposure holes 135a since the user can check only the position of the cap combining spindle 145 from the outside with the naked eye.

Because rotation of the anti-loosening cap 130 is limited when the cap combining spindle 145 is combined with the spindle exposure hole 135a, the position of the nut 120 accommodated in the anti-loosening cap 130 is also fixed, and loosening of the nut 120 is also prevented. Hereinafter, the above will be described in more detail.

Here, the anti-loosening cap 130 according to the preferred embodiment of the present invention has three spindle insertion tubes 137 formed on the inner wall surface of the bolt receiving cap 133 to be spaced apart from one another at an interval of 120 degrees in the circumferential direction. However, it is just one embodiment, and as occasion demands, three or more spindle insertion tubes may be disposed at equiangular intervals.

Meanwhile, a recessed seating surface 132 inwardly recessed from the outer circumferential surface of the bolt receiving cap 133 to a predetermined depth. The cap locking member 150 is detachably combined with the recessed seating surface 132. The recessed seating surface 132 is recessed to the predetermined depth in response to the thickness of the cap locking member 150 so as to fix the position when the cap locking member 150 is fit elastically.

Three locking member insertion long holes 139 formed in the circumferential direction. A valley area 153 of the cap locking member 150 is selectively fit to the three locking member insertion long holes 139, so that the cap locking member 150 is fixed on the recessed seating surface 132.

The three locking member insertion long holes 139 are formed to enhance accessibility of the user. Therefore, because the user can combine the valley area 153 with any one among the tree locking member insertion long holes 139, it can enhance ease of use.

Here, the three locking member insertion long holes 139 are arranged on the same axis as the three spindle insertion tubes 137 formed in the bolt receiving cap 133. So, when the valley area 153 of the cap locking member 150 is inserted into the locking member insertion long hole 139, it gets in contact with the cap combining spindle 145 combined with the spindle insertion tube 137.

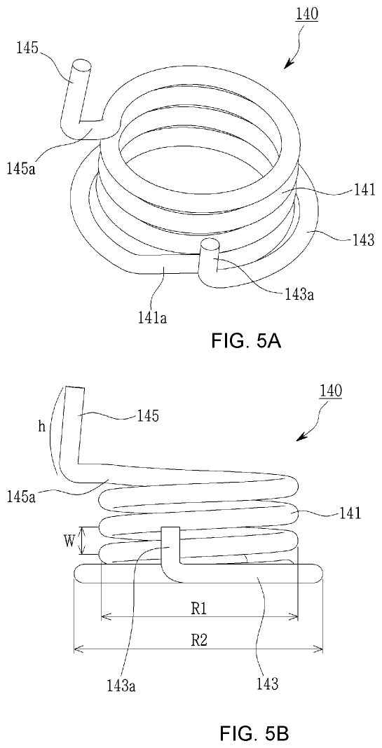

The nut locking member 140 is accommodated into the anti-loosening cap 130 in the state where the nut locking member 140 is combined with the bolt 110 so as to prevent the nut 120 from being loosened. FIG. 5A is a perspective view showing the structure of the nut locking member 140, and FIG. 5B is a side sectional view showing a lateral structure of the nut locking member 140.

As shown in the drawings, the nut locking member 140 includes: a coil spring 141 formed to wind a coil in a direction of the screw thread 113 with a certain number of windings; a lower expanded end 143 extending to a lower portion of the coil spring 141; and the cap combining spindle 145 disposed at an upper end of the coil spring 141, wherein the coil spring 141, the lower expanded end 143, and the cap combining spindle 145 are formed integrally.

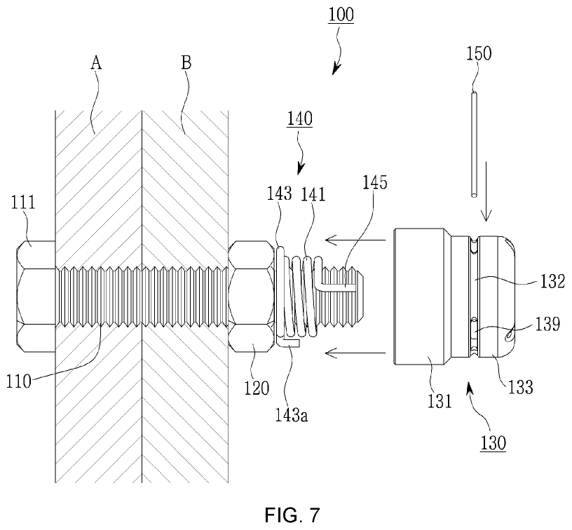

As shown in FIG. 7, when the nut 120 is coupled with the bolt 110 after the bolt 110 penetrates through fastening members A and B, the nut locking member 140 is combined with a rear end of the bolt 110 with which the nut 120 is coupled. The nut locking member 140, together with the nut 120, is accommodated in the anti-loosening cap 130 in order to limit the rotational direction between the nut 120 and the anti-loosening cap 130, so that the nut 120 and the anti-loosening cap 130 are not rotated in the loosening direction.

The coil spring 141 is wound several times at intervals (W) corresponding to pitch of the screw thread 113 of the bolt 110. It is preferable that an inner diameter (R1) of the coil spring 141 be formed corresponding to an outer diameter of the bolt 110 or be formed to be smaller than the outer diameter of the bolt 110 so that the coil spring 141 can apply tension to the bolt 110.

The lower expanded end 143 is formed at a lower portion of the coil spring 141 to be larger than the coil spring 141. The lower expanded end 143 is arranged on the top of the nut 120 and serves to adjust the position of the coil spring 141 so that the cap combining spindle 145 is combined with the spindle insertion tube 137. The lower release spindle 143a is formed at the end portion of the lower expanded end 143 to protrude to a predetermined height in a vertical direction.

The lower release spindle 143a is accommodated in the empty space between the spindle insertion tube 137 and the inner wall surface of the bolt receiving cap 133, and is used to allow the user to grasp it with the hand when dismantling the nut locking member 140.

The lower portion of the coil spring 141 and the lower expanded end 143 are connected to each other by a lower connection end 141a. The lower connection end 141a connects the coil spring 141 and the lower expanded end 143, which have different diameters.

The cap combining spindle 145 is disposed at the top of the coil spring 141 to protrude in the vertical direction and is fixed to the spindle insertion tube 137 of the anti-loosening cap 130. In this instance, because the coil spring 141 is spaced apart from the spindle insertion tube 137, the cap combining spindle 145 is arranged to be separated in the vertical direction by a horizontal connection end 145a. A height (h) of the cap combining spindle 145 is formed to correspond to a height of the spindle insertion tube 137.

As shown in the drawings, the lower release spindle 143a and the cap combining spindle 145 are not located on the same axis but are arranged to have a phase difference at a predetermined angle. That is, the cap combining spindle 145 is formed to be spaced apart from the plurality of spindle insertion tubes 137 within a range not to interfered.

Like the above preferred embodiment of the present invention, in the case that there are three spindle insertion tubes 137, when the anti-loosening cap 130 is combined in the direction of the nut 120, the cap combining spindle 145 is selectively combined with one of the spindle insertion tubes 137.

Because the spindle insertion tube 137 is fit to the spindle exposure holes 135a formed in the outer circumference of the bolt exposure hole 135, if the anti-loosening cap 130 is rotated in the direction that the nut 120 is loosened, the coil spring 141 applies tension to the anti-loosening cap 130 in a direction that the coil spring 141 returns to the initial position. Therefore, the anti-loosening bolt and nut assembly according to the present invention can limit rotation of the anti-loosening cap 130 and the nut 120 in the loosening direction, and stably maintain the coupled state of the nut 120 and the bolt 110.

Here, the rotation of the anti-loosening cap 130 and the nut 120 in the loosening direction is limited by the nut locking member 140, but if vibration is continuously applied to the anti-loosening cap 130 and the nut 120, the anti-loosening cap 130 may be separated from the nut 120 in the opposite direction to the combining direction. Especially, when the bolt 110 is fastened downwardly and the anti-loosening cap 130 is combined with the nut 120 upwardly, gravity and vibration are applied together, and it separates the anti-loosening cap 130 downwardly.

The cap locking member 150 serves to prevent the anti-loosening cap 130 from being separated in the opposite direction to the combining direction.

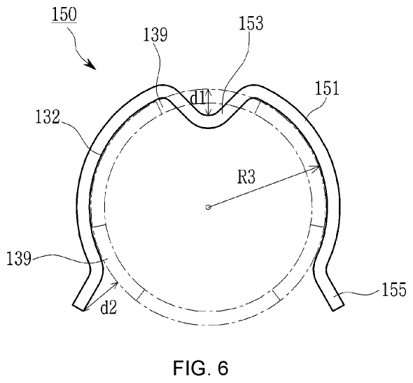

FIG. 6 is a plan view showing a flat composition of the cap locking member 150. As shown in the drawing, the cap locking member 150 is formed in a round ring shape of which some area is opened. The cap locking member 150 includes: a ring-shaped cap locking body 151; a valley area 153 which is recessed at a middle area of the cap locking body 151 inwardly in the radial direction; and a pair of outer curved free ends 155 formed at both ends of the cap locking body 151 to protrude outwardly in the radial direction.

The cap locking body 151 is elastically caught and joined to the recessed seating surface 132 of the anti-loosening cap 130. As shown in FIG. 6, a radius (R3) of the cap locking member 151 corresponds to the outer diameter of the recessed seating surface 132 or is formed to be smaller than the outer diameter of the recessed seating surface 132. Therefore, the cap locking body 151 is elastically expanded and is caught to the recessed seating surface 132 to be fixed in its position.

In this instance, the valley area 153 is inserted into one among the three locking member insertion long holes 139, and a pair of the outer curved free ends 155 are located in the remaining two locking member insertion hole holes 139 to be fixed.

As shown in FIG. 8, an inwardly recessed depth (d1) of the valley area 153 is a depth that the valley area 153 is interfered with the horizontal connection end 145a or the cap combining spindle 145 in the state where the valley area 153 is inserted into the bolt receiving cap 133.

As shown in FIG. 8, when the anti-loosening cap 130 is moved in an arrow direction, namely, in the opposite direction to the combining direction by the external shock, the valley area 153 gets in contact with the cap combining spindle 145 or the horizontal connection end 145a to be blocked. Therefore, the anti-loosening cap 130 is not moved in the opposite direction to the combining direction.

In the meantime, a pair of the outer curved free ends 155 protrude outwardly in the radial direction to a predetermined length (d2). So, the user grasps a pair of the outer curved free ends 155 and elastically expands the outer curved free ends 155, and then, separates the cap locking body 151 from the recessed seating surface 132 of the anti-loosening cap 130.

Now, referring to FIGS. 1 to 8, a use process of the anti-loosening bolt and nut assembly 100 according to the present invention will be described.

As shown in FIG. 3, the user prepares the bolt 110, the nut 120, the anti-loosening cap 130, the nut locking member 140, and the cap locking member 150. In this instance, the anti-loosening cap 130, the nut locking member 140, and the cap locking member 150 with various kinds are prepared according to various standards of the bolt 110 and the nut 120, and are selected depending on the standards of the bolt 110 and the nut 120 to be used. As occasion demands, the anti-loosening bolt and nut assembly 100 may be packaged to be sold.

When the components are prepared, as shown in FIG. 7, the user inserts the bolt 110 into the members A and B to be fastened, and screw-couples the nut 120 with the bolt 110. After that, the user combines the nut locking member 140 with the rear end of the bolt 110 outwardly protruding over the nut 120. The user inserts the lower expanded end 143 into the bolt 110 to face downwards and rotates the coil spring 141 in the combining direction so that the nut locking member 140 is joined toward the nut 120.

After the lower expanded end 143 gets in contact with the upper surface of the nut 120, the user covers the anti-loosening cap 130 in such a way that the nut 120 and the nut locking member 140 are accommodated therein. In this instance, the user covers the anti-loosening cap 130 such that the spindle insertion tube 137 is located corresponding to the positions of the lower release spindle 143a and the cap combining spindle 145 of the nut locking member 140.

When the anti-loosening cap 130 is moved toward the nut 120, the cap combining spindle 145 protruding at the upper portion is first fit to one among the three spindle insertion tubes 137.

The anti-loosening cap 130 further moves toward the nut 120 so that the nut 120 is completely accommodated in the nut receiving cap 131. Therefore, the nut fixing protrusions 131a of the nut receiving cap 131 hold the position of the nut 120 not to be rotated while getting in contact with the hexagonal surface of the nut 120.

When the anti-loosening cap 130 is completely combined with the nut 120, the cap combining spindle 145 is fit to the spindle insertion tube 137.

When the combination between the anti-loosening cap 130 and the nut 120 is finished, the user combines the cap locking member 150 with the anti-loosening cap 130. When the user presses the anti-loosening cap 130 to locate the valley area 153 of the cap locking member 150 in the locking member insertion long hole 139, the outer curved free ends 155 are fit in the recessed seating surface 132 while being expanded by elasticity so that the position of the outer curved free ends 155 can be fixed firmly.

In this instance, the valley area 153 and a pair of the outer curved free ends 155 of the cap locking member 150 are respectively inserted and located in the three locking member insertion long holes 139 to fix the position of the cap locking member 150.

When the anti-loosening bolt and nut assembly 100 is assembled completely, as shown in FIG. 8, the nut receiving cap 131 of the anti-loosening cap 130 covers the nut 120.

Moreover, the coil spring 141 is accommodated in the bolt receiving cap 133 in the state where the lower expanded end 143 of the nut locking member 140 is combined with the upper surface of the nut 120.

Furthermore, if vibration is continuously applied in the direction that the bolt receiving cap 133 is separated from the nut 120, power to move the bolt receiving cap 133 in the arrow direction of FIG. 8 acts. In this instance, the valley area 153 of the cap locking member 150 inserted into the bolt receiving cap 133 through the locking member insertion long holes 139 comes into contact with the cap combining spindle 145 or the horizontal connection end 145a.

Because it is impossible to move further when the valley area 153 is blocked by the cap combining spindle 145 or the horizontal connection end 145a, the bolt receiving cap 133 is not moved in the direction that the bolt receiving cap 133 is separated from the nut 120 anymore, and is fixed in its position. Therefore, the bolt receiving cap 133 can be rotated only in the direction that the nut 120 is coupled with the bolt 110 but cannot be rotated and moved in the other directions.

Therefore, the coupled state between the bolt 110 and the nut 120 can be stably maintained for a long time even though shock or vibration is applied in various directions for a long time, and the combined state of the fastening members A and B can be firmly maintained.

Meanwhile, in the present invention, the cap locking member 150 is formed in the round ring shape, but may have any other shapes if the cap locking member 150 is inserted into the locking member insertion long hole 139 and gets in contact with the cap combining spindle 145 or the horizontal connection end 145a. Therefore, if necessary, the cap locking member 150 may be a plate spring having a protrusion or a groove part inserted into the locking member insertion long hole 139.

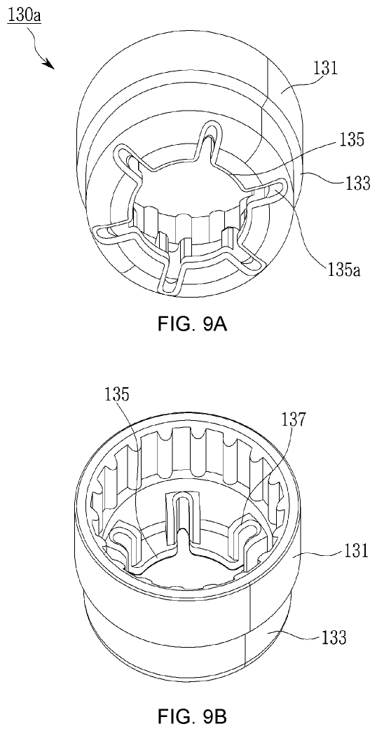

In the meantime, FIGS. 9A and 9B show a modification of the anti-loosening cap 130a of the present invention. The anti-loosening cap 130 according to the previously described preferred embodiment includes the tree spindle insertion tubes 137 formed therein and the recessed seating surface 132 formed on the outer face thereof to be combined with the cap locking member 150.

On the other hand, an anti-loosening cap 130a according to the modification of the present invention does not include the recessed seating surface 132 and is not combined with the cap locking member 150. Instead, six spindle insertion tubes 137 are formed in the anti-loosening cap 130a, so that the user can easily combine the nut locking member 140 with the anti-loosening cap 130a.

As described above, the anti-loosening bolt and nut assembly according to the present invention limits what the anti-loosening cap is rotated in the loosening direction of the nut since the nut locking member accommodated in the anti-loosening cap together with the nut applies tension in the direction that the nut is coupled with the bolt.

Moreover, the cap locking member combined with the outer circumference of the anti-loosening cap is inserted into the anti-loosening cap and gets in contact with the nut locking member so as to limit movement of the anti-loosening cap in the direction that the anti-loosening cap is separated from the nut.

Due to the action between the nut locking member and the cap locking member, the anti-loosening cap can rotate only in the direction that the nut is coupled to the bolt and cannot be rotated and moved in the other directions.

Therefore, even though shock and vibration are applied in various direction, the coupled state between the bolt and the nut can be maintained stably, and the combined state of the fastening members combined by the bolt and nut can be firmly maintained.

What is claimed is:

1. An anti-loosening bolt and nut assembly comprising:
a bolt inserted into an object to be fastened;
a nut screw-coupled with a screw thread of the bolt;
an anti-loosening cap for receiving the nut therein to prevent the nut from moving in a loosening direction that the nut is released from the bolt; and
a nut locking member coupled with the screw thread of the bolt penetrating through the nut, and accommodated in the anti-loosening cap together with the nut in order to limit a rotational direction of the anti-loosening cap so that the nut is not rotated in the loosening direction,
wherein the anti-loosening cap includes:
a nut receiving cap for receiving the nut therein; and
a bolt receiving cap disposed at an upper portion of the nut receiving cap and having a bolt exposure hole for exposing an end portion of the bolt penetrating through the nut to the outside, and
wherein the nut locking member includes a coil spring coupled with the screw thread of the bolt, which penetrates through the nut, in a predetermined length to limit the rotational direction of the anti-loosening cap.

2. The anti-loosening bolt and nut assembly according to claim 1, wherein the nut locking member includes:
a lower release spindle protruding from an end portion of the coil spring to a predetermined length in a vertical direction; and
a cap combining spindle protruding from the top of the coil spring to a predetermined length in a vertical direction,
wherein spindle insertion tubes to which the cap combining spindle is forcedly fit are formed on the inner wall surface of the bolt receiving cap, and
wherein a spindle exposure hole is disposed on the outer circumferential surface of the bolt exposure hole to be communicated with the spindle insertion tube.

3. The anti-loosening bolt and nut assembly according to claim 1, further comprising:
a recessed seating surface which is formed in a boundary area between the nut receiving cap and the bolt receiving cap to be inwardly recessed in a radial direction;
a locking member insertion long hole formed in the recessed seating surface in a circumferential direction; and
a cap locking member elastically and forcedly fit to the recessed seating surface, inserted onto the recessed seating surface to get in contact with a lower portion of the cap combining spindle through, and limited in movement in the direction that the anti-loosening cap is separated from the nut.

4. The anti-loosening bolt and nut assembly according to claim 3, wherein the nut locking member further includes a lower expanded end, which is disposed at the bottom of the coil spring to have a diameter larger than that of the coil spring and has a lower release spindle formed at an end portion thereof.

5. The anti-loosening bolt and nut assembly according to claim 3, wherein the cap locking member includes:
a cap locking body of which some area having an inner diameter corresponding to an outer diameter of the recessed seating surface is opened;
a valley area recessed at a middle area of the cap locking body inwardly in the radial direction and inserted into the locking member insertion long hole; and
a pair of outer curved free ends formed at both ends of the cap locking body to protrude outwardly in the radial direction,
wherein the valley area is inserted into the locking member insertion long hole to a depth to get in contact with the cap combining spindle.

6. The anti-loosening bolt and nut assembly according to claim 2, further comprising:
a recessed seating surface which is formed in a boundary area between the nut receiving cap and the bolt receiving cap to be inwardly recessed in a radial direction;
a locking member insertion long hole formed in the recessed seating surface in a circumferential direction; and
a cap locking member elastically and forcedly fit to the recessed seating surface, inserted onto the recessed seating surface to get in contact with a lower portion of the cap combining spindle through, and limited in movement in the direction that the anti-loosening cap is separated from the nut.

7. The anti-loosening bolt and nut assembly according to claim 6, wherein the nut locking member further includes a lower expanded end, which is disposed at the bottom of the coil spring to have a diameter larger than that of the coil spring and has a lower release spindle formed at an end portion thereof.

8. The anti-loosening bolt and nut assembly according to claim 6, wherein the cap locking member includes:
a cap locking body of which some area having an inner diameter corresponding to an outer diameter of the recessed seating surface is opened;
a valley area recessed at a middle area of the cap locking body inwardly in the radial direction and inserted into the locking member insertion long hole; and
a pair of outer curved free ends formed at both ends of the cap locking body to protrude outwardly in the radial direction,
wherein the valley area is inserted into the locking member insertion long hole to a depth to get in contact with the cap combining spindle.
